(19) United States
(12) Patent Application Publication
(10) Pub. No.: US 2019/0392032 A1
(43) Pub. Date: Dec. 26, 2019

(54) DISPLAY SYSTEM, PROGRAM, AND STORAGE MEDIUM

(71) Applicant: KABUSHIKI KAISHA TOSHIBA, Minato-ku (JP)

(72) Inventors: Hideki YASUI, Ota (JP); Keiichi SANO, Yokohama (JP); Masaya MOTOKUBOTA, Yokohama (JP); Koichi YAMAGATA, Kamakura (JP)

(73) Assignee: KABUSHIKI KAISHA TOSHIBA, Minato-ku (JP)

(21) Appl. No.: 16/364,600

(22) Filed: Mar. 26, 2019

(30) Foreign Application Priority Data
Jun. 25, 2018 (JP) 2018-120158

(51) Int. Cl. G06F 17/24; G06F 17/27; G06F 16/36; G06F 16/31; G06F 3/0482

(52) U.S. Cl. CPC G06F 17/246; G06F 17/277; G06F 3/0482; G06F 16/367; G06F 16/31; G06F 17/2795

(57) ABSTRACT

According to one embodiment, a display system includes a processing device. The processing device is operable for, upon receiving a sentence inputted by a user, extracting a keyword from the sentence, and generating a chart related to the keyword from prescribed data and displaying the chart on a first screen.

### CROSS-REFERENCE TO RELATED APPLICATIONS

This application is based upon and claims the benefit of priority from Japanese Patent Application No. 2018-120158, filed on Jun. 25, 2018; the entire contents of which are incorporated herein by reference.

### FIELD

Embodiments described herein relate generally to a display system, a program, and a storage medium.

### BACKGROUND

There is known a system capable of automatically generating a chart from prescribed data. Further improvement in convenience is desired for this system.

### BRIEF DESCRIPTION OF THE DRAWINGS

FIG. 1 is a block diagram showing the configuration of a display system according to an embodiment;

FIG. 2 is a schematic view showing an output example of the display system according to the embodiment;

FIG. 3 is a flow chart showing the operation of the display system according to the embodiment;

FIG. 4 is a flow chart showing the flow of data registration in the display system according to the embodiment;

FIG. 5 is a table illustrating column attributes;

FIG. 6 is a table illustrating registered data;

FIGS. 7A and 7B are tables illustrating a column attribute table;

FIG. 8 is a schematic view illustrating a screen for setting the column attribute table;

FIG. 9 is a flow chart showing the flow of learning in the display system according to the embodiment;

FIG. 10 is a schematic view showing an output example of the display system according to the embodiment;

FIG. 11 is a table illustrating a main table;

FIGS. 12A and 12B are tables illustrating a column attribute table;

FIGS. 13A and 13B are tables illustrating an X-axis attribute table;

FIGS. 14A to 14D are tables illustrating the column attribute table and the X-axis table;

FIGS. 15A to 15C are tables illustrating the column attribute table and the chart kind table;

FIGS. 16A to 16D are tables illustrating the X-axis table, the Y-axis table, the column attribute table, and the chart kind table;

FIG. 17 is a schematic view showing an output example of the display system according to the embodiment; and

FIG. 18 is a schematic view showing an output example of the display system according to the embodiment

### DETAILED DESCRIPTION

According to one embodiment, a display system includes a processing device. The processing device is operable for, upon receiving a sentence inputted by a user, extracting a keyword from the sentence, and generating a chart related to the keyword from prescribed data and displaying the chart on a first screen.

According to one embodiment, a display system includes a processing device. The processing device is operable for, upon receiving a first sentence inputted by a user, extracting a first keyword from the first sentence, referring to a learned table and generating a first chart related to the first keyword from prescribed data, and displaying the first chart on a first screen. In learning of the table, the processing device updates the table based on a second sentence inputted by the user, a second chart displayed based on the second sentence, and an evaluation of the second chart inputted by the user.

According to one embodiment, a program is configured to cause a processing device to perform, upon input of a sentence by a user, extracting a keyword from the sentence, generating a chart related to the keyword from prescribed data, and displaying the chart on a first screen.

According to one embodiment, a storage medium is the storage medium on which the program is stored.

Various embodiments are described below with reference to the accompanying drawings.

In the specification and drawings, components similar to those described previously or illustrated in an antecedent drawing are marked with like reference numerals, and a detailed description is omitted as appropriate.

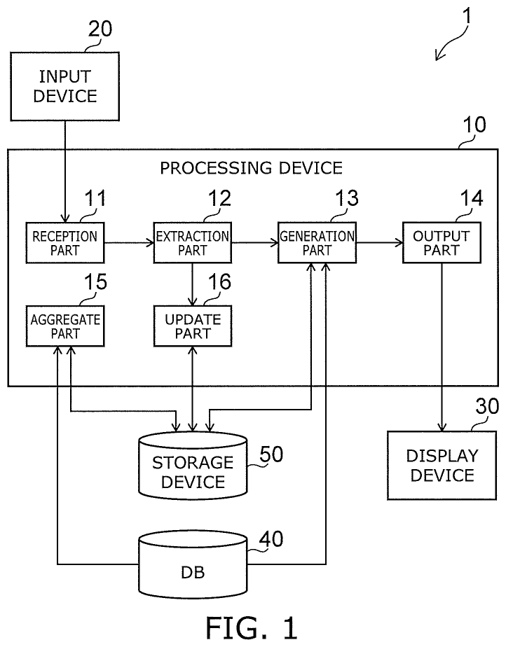

FIG. 1 is a block diagram showing the configuration of a display system according to an embodiment.

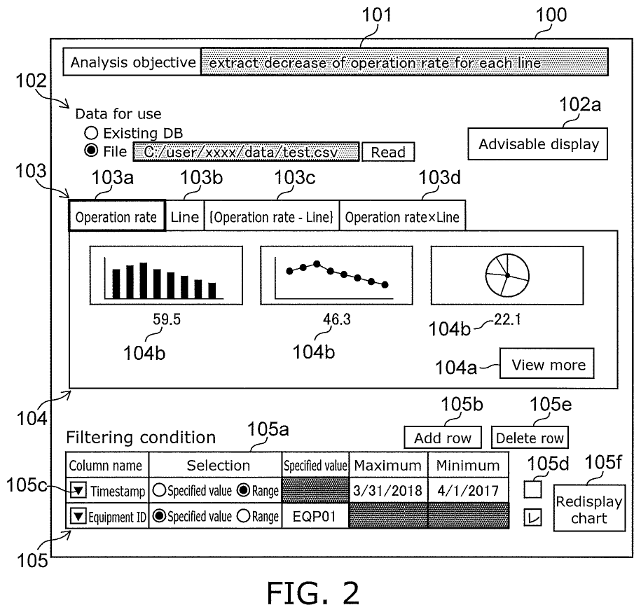

FIG. 2 is a schematic view showing an output example of the display system according to the embodiment.

The display system 1 according to the embodiment is used when a user creates a chart based on certain data. Specifically, the display system 1 automatically generates a chart suitable for the user's analysis objective and displays the chart to the user.

As shown in FIG. 1, the display system 1 includes a processing device 10. The processing device 10 includes e.g. a reception part 11, an extraction part 12, a generation part 13, and an output part 14.

The reception part 11 receives information inputted by an input device 20. The input device 20 includes at least one of e.g. a keyboard, mouse, microphone (audio input), and touch panel. The user inputs the objective of creating a chart (analysis objective) to the processing device 10 using the input device 20. The extraction part 12 extracts a keyword (first keyword) from the sentence (first sentence) indicating the analysis objective.

After the keyword is extracted, the generation part 13 generates a chart (first chart) related to the keyword from prescribed data based on the keyword. For instance, the generation part 13 accesses a database 40 and generates a chart from the data stored in the database 40. The database 40 is stored in e.g. a hard disk drive attached to the processing device 10, or e.g. a file server or network hard disk connected to the processing device 10 through a network. Alternatively, the generation part 13 may generate a chart from the data stored in a storage medium specified by the user.

The generation part 13 accesses a storage device 50 when generating a chart. The storage device 50 stores information (table) used to generate a chart. The generation part 13 refers to the information and generates a chart. The storage device 50 is stored in e.g. a hard disk drive attached to the processing device 10, or e.g. a file server or network hard disk connected to the processing device 10 through a network. The storage device 50 may store the database 40.

The output part 14 externally outputs and displays the generated chart. For instance, the output part 14 displays the chart on a display device 30. The display device 30 is e.g. a display or a touch panel.

The output part 14 displays e.g. a screen (user interface) 100 (first screen) shown in FIG. 2 on the display device 30. The screen 100 includes an input field 101, an item 102, a keyword display area 103, and a chart display area 104. The input field 101 is inputted with a sentence indicating the analysis objective. The item 102 is used to specify the data to be analyzed.

For instance, as shown in FIG. 2, the user uses the input device 20 to input “extract decrease of operation rate for each line” to the input field 101. Next, the user specifies data used for analysis in the item 102 and clicks the button 102a. The processing device 10 extracts a keyword from the sentence of the input field 101. The processing device 10 automatically generates a chart related to the keyword from the specified data.

The keyword display area 103 displays the extracted keyword. In this example, “operation rate” and “line” are extracted as keywords. The chart display area 104 displays the chart related to the keyword. When a plurality of keywords are extracted, related charts are generated for each keyword and combinations of the keywords.

The chart display area 104 displays one or more charts.

For instance, the image file of the chart and the data used to generate the chart can be downloaded by using a double click to select one of the displayed charts. When the user clicks the button 104a, still another chart is displayed. The other chart may be displayed on the screen 100, or may be displayed on another screen switched from the screen 100.

The output part 14 may further display a numerical value 104b indicating the relevance of the chart to the sentence of the input field 101. The numerical value 104b indicates e.g. how much each chart is matched with the user's analysis objective. This numerical value is referred to as advisability. For instance, when generating a chart, the generation part 13 calculates the advisability of each chart. The output part 14 displays the charts in the chart display area 104 in the descending order of advisability.

For instance, the keyword display area 103 displays a plurality of tabs. Tabs 103a-103d are displayed in the example shown in FIG. 2. When the user clicks the tab 103a or 103b, the chart display area 104 displays a chart related only to “operation rate” or only to “line”. When the user clicks the tab 103c, “operation rate” and “line” are treated as one keyword, and the chart related to the keyword is displayed. When the user clicks the tab 103d, the chart related to both “operation rate” and “line” is displayed.

When the user intends to change the range used to generate a chart for the data specified in the item 102, the user sets the item 105. The item 105 includes a table 105a for setting a filtering condition. In the filtering condition, the user can specify which range is used to generate a chart in each column of the data.

As the item 105, e.g. the table 105a shown in FIG. 2 may be displayed on the screen 100. Alternatively, e.g. an icon for transition to another screen displaying the table may be displayed on the screen 100.

For instance, in the item 105, a blank row is added to the table 105a by the “Add row” button 105b. Upon clicking the symbol 105c of the “Column name” cell, a list of selectable items is displayed. In selection, the specified value or range is selected. In response to this selection, one of the cells is grayed out so as to disable input of the specified value or input of the maximum and minimum. Upon checking the checkbox 105d to the right of the table 105a and clicking the “Delete row” button 105e, the row is deleted. The filtering condition is enabled by clicking the “Redisplay chart” button 105f. Upon clicking the button 105f, a chart based on the filtering condition can be redisplayed in the chart display area 104.

The display system 1 may be provided with only the processing device 10, or may be further provided with at least one of the input device 20, the display device 30, the database 40, and the storage device 50. The processing device 10 is connected to the input device 20 and the display device 30 through a wired or wireless connection. The processing device 10 may be connected to the database 40 and the storage device 50 through a wired or wireless connection, or through a network. In the example shown in FIG. 1, the processing device 10 further includes an aggregate part 15 and an update part 16. The aggregate part 15 and the update part 16 are described later.

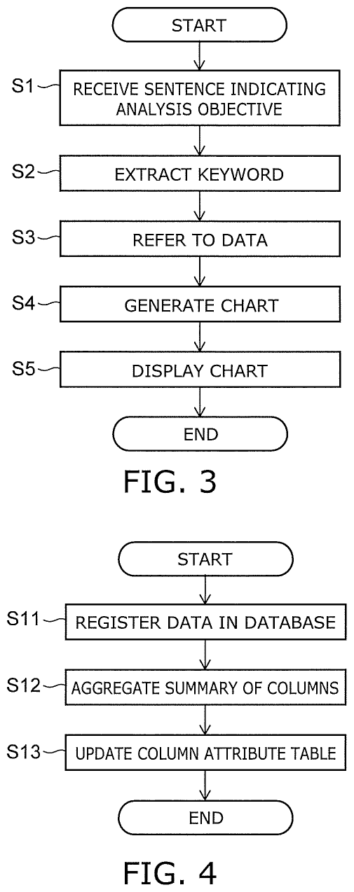

FIG. 3 is a flow chart showing the operation of the display system according to the embodiment.

When a sentence indicating the analysis objective is inputted by the user, the reception part 11 receives the input (step S1). The extraction part 12 extracts a keyword from the sentence (step S2). The generation part 13 refers to prescribed data (step S3). The generation part 13 generates a chart related to the keyword from the data (step S4). The output part 14 displays the generated chart (step S5).

The effect of the embodiment is described.

In general, a chart is often created in analyzing data. For instance, the correlation of certain information with other information contained in the data can be analyzed by creating a chart. On the other hand, there are various kinds of charts such as a bar chart, line chart, area chart, pie chart, percentage bar chart, and scatter diagram. The data may contain a large amount of information. When creating a chart, an effective analysis based on the chart is difficult unless the information used is displayed by a suitable kind of chart. When a person with a small experience in analysis creates a chart, the person creates a chart unstable for analysis, or takes much time to create a suitable chart.

In the display system 1 according to the embodiment, when the user inputs a sentence indicating the analysis objective, the processing device 10 extracts a keyword from the sentence. Furthermore, the processing device 10 automatically generates a chart related to the keyword from prescribed data and displays the chart. The user does not need to create a chart in person. The user can easily obtain a chart adapted to the analysis objective. The embodiment can improve convenience of the display system 1.

In the display system 1, as shown in FIG. 2, the extracted keyword is displayed in the keyword display area 103. Thus, the user can easily know the keyword used to generate the chart, and which keyword is related to the chart.

Furthermore, when a plurality of keywords are extracted from the sentence of the input field 101, a tab is displayed for each keyword in the keyword display area 103. The user can display a chart based on one of the plurality of extracted keywords by selecting one of a plurality of tabs.

Furthermore, when a plurality of keywords are extracted from the sentence of the input field 101, a tab regarding a combination of keywords is displayed in the keyword display area 103. The user can display a chart based on a combination of keywords by selecting the tab. As shown in FIG. 2, for instance, the combination may treat a plurality of keywords as one keyword, or may be an “AND” combination of a plurality of keywords. Alternatively, for instance, the displayed chart may be related to one keyword but not related to other keywords.

The user can select the range of data used to generate a chart by setting the item 105. For instance, to analyze data within a specific time period, the range of the time period can be specified by setting the item 105. Thus, the user can create a chart suitable for the intended analysis objective more easily.

A specific operation of the display system 1 according to the embodiment is described.

Before the user uses the display system 1 to generate a chart, data registration and learning are performed in the display system 1. The operation of the display system 1 in data registration and learning is described below.

### (Data Registration)

FIG. 4 is a flow chart showing the flow of data registration in the display system according to the embodiment.

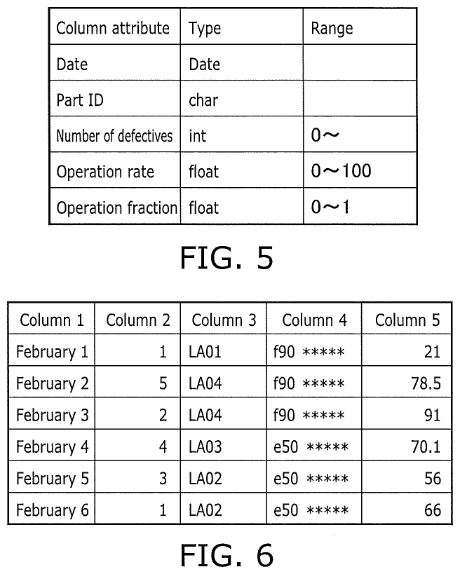

FIG. 5 is a table illustrating column attributes.

FIG. 6 is a table illustrating registered data.

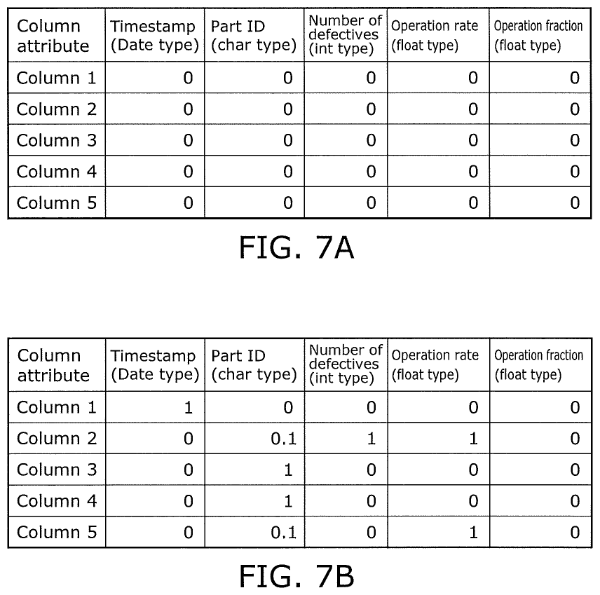

FIGS. 7A and 7B are tables illustrating a column attribute table.

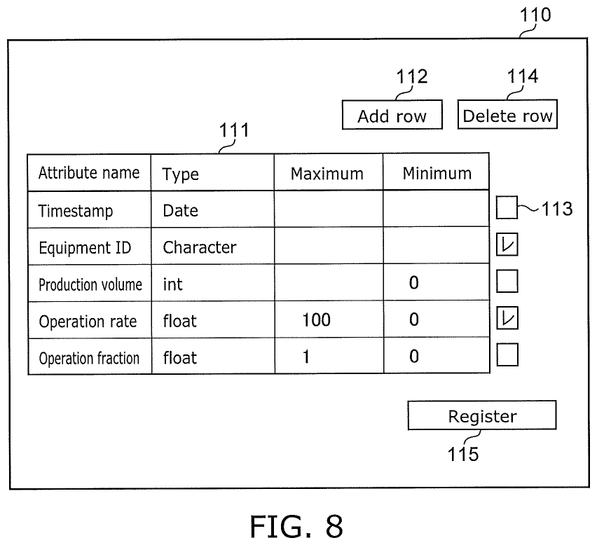

FIG. 8 is a schematic view illustrating a screen for setting the column attribute table.

As shown in FIG. 4, the user first registers data in the database 40 (step S11). The registered data is used for learning of the display system 1. This data may be used in generating and displaying a chart by the display system 1 shown in FIGS. 2 and 3. The file format used for the data is a format readable by spreadsheet software such as Microsoft Excel (registered trademark). For instance, the file format of the data is spreadsheet, CSV (comma-separated values), or text.

Upon registration of data in the database 40, the aggregate part 15 accesses the database 40. The aggregate part 15 reads the registered data and aggregates the summary of columns contained in the data (step S12). Specifically, the aggregate part 15 classifies the input content contained in each column of the registered data into several types.

The storage device 50 stores the name of column attributes and the type of the column attributes in advance. FIG. 5 shows an example thereof. For instance, as shown in FIG. 5, the column attribute is classified into one type of the date type, char (character) type, int (integer) type, and float (floating-point number) type. The int type and the float type may be further specified by a possible range of the numerical value.

The data includes e.g. columns 1-5 as shown in FIG. 6. The aggregate part 15 determines the content contained in each column and identifies its type based on the information defined in the storage device 50. For instance, the types include the date type, char type, int type, and float type. One column may be applicable to a plurality of types. In the example of FIG. 6, column 1 is classified as the date type. Column 2 is classified as the int type or float type. Column 3 and column 4 are classified as the char type. Column 5 is classified as the float type.

After classifying the type of each column contained in the data, the aggregate part 15 aggregates the classification result. The aggregate part 15 updates the column attribute table based on the aggregated result (step S13). The column attribute table indicates the likelihood that each column of the data has a particular column attribute. FIG. 7A shows an example of the column attribute table. In the column attribute table, a higher point of the column attribute set to a particular column indicates a higher probability that the particular column has the column attribute.

FIG. 7A shows a column attribute table before data registration. In the initial state, all the points of the table are set to 0. For instance, the aggregate part 15 compares the classification result of the type of the column with the type of each attribute candidate. Furthermore, for the columns classified as the int type and float type, the range of the numerical value is extracted and compared with the preset numerical range of the column attribute.

For the date type and char type, when the type is matched, the point in the table is incremented by 1. For the int type and float type, when the type is matched and the numerical range of data is contained in the preset numerical range, the point in the table is incremented by 1. For the int type and float type, furthermore, the char type is also incremented by 0.1. This is because even when a column is classified as the int or float type, it may be used as a character string.

FIG. 7B shows a result of updating the column attribute table in accordance with the abovementioned rule. The aggregate part 15 stores the updated column attribute table in the storage device 50. When a plurality of data are registered, the column attribute table is updated for each time of registration. Thus, data registration is completed.

FIG. 8 is a schematic view illustrating a screen for setting a column attribute table.

The output part 14 displays e.g. a screen 110 shown in FIG. 8 on the display device 30. The screen 110 includes a table 111 indicating currently registered column attributes. When the user clicks the “Add row” button 112, a blank row is added to the bottom of the table 111. The user inputs information of the column attribute in the existing row or added row. Specifically, the user inputs the name and data type of the attribute. When the type is int or float, the user may further input the range thereof. Upon checking the checkbox 113 to the right of the table 111 and clicking the “Delete row” button 114, the specified row is deleted. Upon clicking the “Register” button 115, the information in the table 111 can be registered as column attributes. When the input content is inadequate, e.g. an error message is displayed and the registration process is suspended.

### (Learning)

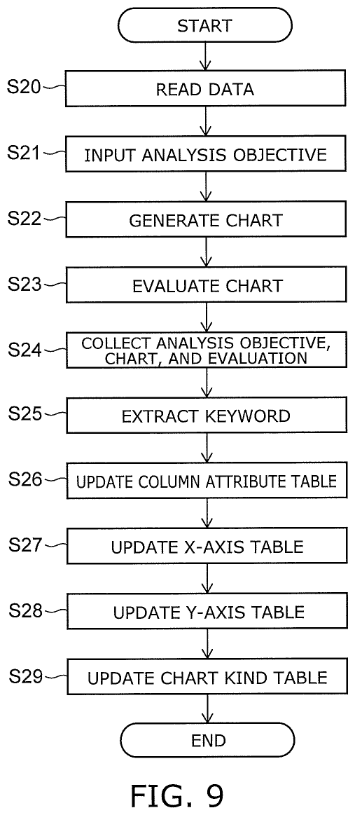

FIG. 9 is a flow chart showing the flow of learning in the display system according to the embodiment.

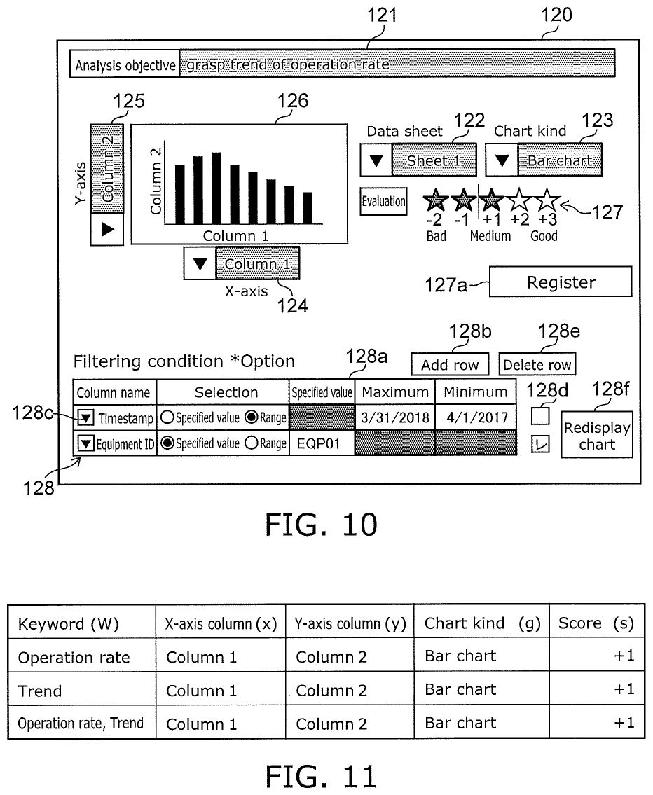

FIG. 10 is a schematic view showing an output example of the display system according to the embodiment.

FIGS. 11 to 13 are tables illustrating a main table, a column attribute table, and an X-axis attribute table, respectively.

As shown in FIG. 9, the user first reads data registered in the database 40 (step S20). When reading is completed, the processing device 10 displays e.g. a screen 120 shown in FIG. 10. The screen 120 displays an input field 121, items 122-125, a chart display area 126, and an item 127.

The user inputs a sentence indicating the analysis objective in the input field 121 (step S21). Furthermore, the user sets the items 122-125 and causes the display system 1 to generate a chart (step S22). The generation part 13 generates a chart based on the information of the input field 121 and the items 122-125. The output part 14 displays the chart in the chart display area 126.

The item 122 is inputted with information specifying the data for use from among the read data. For instance, when the read data contains a plurality of sheets, a sheet used to generate a chart is specified in the item 122. The item 123 is inputted with the kind of a chart to be created. The items 124 and 125 are specified with the column used for the X-axis and the Y-axis, respectively, from among the columns included in the data specified in the item 122. In the items 122-125, for instance, upon clicking the left-side symbol, a list of selectable items is displayed as a drop-down list.

When the chart is displayed, the user inputs evaluation of the chart in the item 127 (step S23). The evaluation is determined by selecting the number of stars in the item 127. A larger number of stars correspond to a higher evaluation and indicate that the displayed chart is more suitable for the analysis objective. The user inputs the evaluation of the chart in the item 127 and clicks the box 127a to register the evaluation.

The screen 120 may further display an item 128. The item 128 includes a table 128a for setting a filtering condition. Upon clicking the “Add row” button 128b, a blank row is added to the bottom of the table 128a. Upon clicking the symbol 128c of the “Column name” cell, a list of selectable columns is displayed. In “Selection”, “Specified value” or “Range” is selected. In response to this selection, the specified value or the maximum/minimum is grayed out so as to disable input. Upon checking the right-side checkbox 128d and clicking the “Delete row” button 128e, the row is deleted. The filtering condition is enabled by clicking the “Redisplay chart” button 128f. Upon clicking the button 128f, a chart reflecting the filtering condition is redisplayed in the chart display area 126.

When the box 127a is clicked, the reception part 11 receives input of the sentence of the input field 121 (second sentence), the displayed chart (second chart), and the evaluation and collects information thereof (step S24). The extraction part 12 extracts a keyword (second keyword) from the sentence (step S25). The keyword is extracted using e.g. the named entity extraction technique.

The update part 16 updates the table stored in the storage device 50 based on the collected information and the keyword. For instance, the storage device 50 stores a main table, a column attribute table, an X-axis table, a Y-axis table, and a chart kind table. The update part 16 first incorporates the collected information and the keyword into the main table. The update part 16 stores the updated main table in the storage device 50.

As an example, as shown in FIG. 10, the input field 121 is inputted with “grasp trend of operation rate” as an analysis objective. The items 122-125 are set, and a chart based thereon is displayed in the chart display area 126. This chart is evaluated as “medium (+1)” in the item 127. The value “+1” is treated as a score indicating evaluation. As shown in FIG. 11, the main table stores the keyword, the column used for the X-axis, the column used for the Y-axis, the kind of chart, and the score. When evaluation is performed by the user, the update part 16 adds information indicating their correspondence to the main table as shown in FIG. 11.

After updating the main table, the update part 16 further updates the column attribute table (step S26), the X-axis table (step S27), the Y-axis table (step S28), and the chart kind table (step S29).

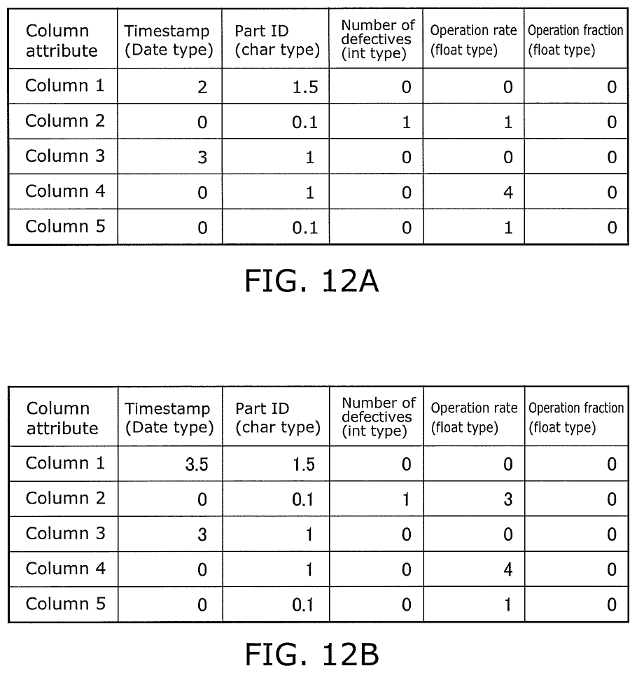

As shown in FIG. 12A, the column attribute table includes the name of column attributes. The column attribute table of FIG. 12A is different from the column attribute table of FIG. 7B. For instance, FIG. 12A shows the state in which the column attribute table of FIG. 7B is further updated. The column attribute table of FIG. 12A illustrates the state before update is performed by the update part 16. The update part 16 calculates similarity between the extracted keyword and the name of the column attribute. The update part 16 updates the column attribute table based on the calculation result of the similarity.

In the example shown in FIGS. 10 and 11, “operation rate” and “trend” are extracted as keywords. The column attribute table includes “Time”, “Part ID”, “Number of defectives”, “Operation rate”, and “Operation fraction” as the name of column attributes. The update part 16 calculates similarity of each of “operation rate” and “trend” to each of “Time”, “Part ID”, “Number of defectives”, “Operation rate”, and “Operation fraction”.

When calculating the similarity, the update part 16 refers to a database related to synonyms. This database stores a word, a sememe possessed by the word, and other words (synonyms) possessing the sememe. This database may be stored in the storage device 50. When the synonyms of the keyword include the name of a column attribute, the keyword is likely to be similar to that column attribute.

For instance, when the extracted keyword is matched with the name of a column attribute, the update part 16 increments the corresponding point in the table by 2. When the keyword is not completely matched with the name but at least part of the keyword is matched with at least part of the name, the point in the table is incremented by 1. When the sememe or synonym of the keyword is matched with the sememe or synonym of the name, the point in the table is incremented by 1. When the sememe is not completely matched but at least part of the sememe of the keyword is matched with at least part of the sememe of the name, the point in the table is incremented by 0.5. Likewise, when the synonym is not completely matched but at least part of the synonym of the keyword is matched with at least part of the synonym of the name, the point in the table is incremented by 0.5. In any of the above cases, the point is not updated for locations where the data type is not matched (locations where the point is 0).

The update part 16 updates the column attribute table shown in FIG. 12A in accordance with the aforementioned rule. For instance, suppose that part of the sememe of “operation rate” is matched with part of the sememe of “timestamp”. Thus, the point of the “timestamp” attribute for column 1 is incremented by 0.5. Suppose that the synonyms of “trend” include “timestamp”. Thus, the point of the “timestamp” attribute for column 1 is further incremented by 1. The keyword “operation rate” is completely matched with the attribute name “operation rate”. Thus, the point of the “operation rate” attribute for column 2 is incremented by 2. The keyword “operation rate” is partially matched with the attribute name “operation fraction”. However, the data type is not matched. Thus, the point is not updated. Consequently, the column attribute table is updated as shown in FIG. 12B. The update part 16 stores the updated column attribute table in the storage device 50.

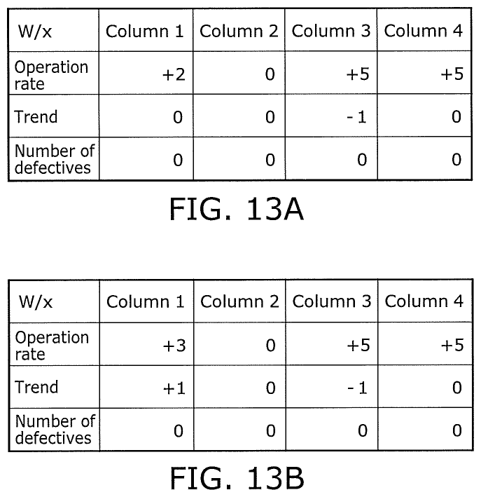

The X-axis table stores the probability that each column is used for the X-axis when a particular keyword is used. The probability is represented in e.g. points as shown in FIG. 13A. In the example shown in FIGS. 10 and 11, “operation rate” and “trend” are extracted as keywords, and column 1 is used for the X-axis. Based on this result, the update part 16 raises the probability that column 1 is used for the X-axis when “operation rate” and “trend” are included in the analysis objective. For instance, as shown in FIG. 13B, the point of “operation rate” corresponding to column 1 and the point of “trend” corresponding to column 1 are incremented by the registered score (+1).

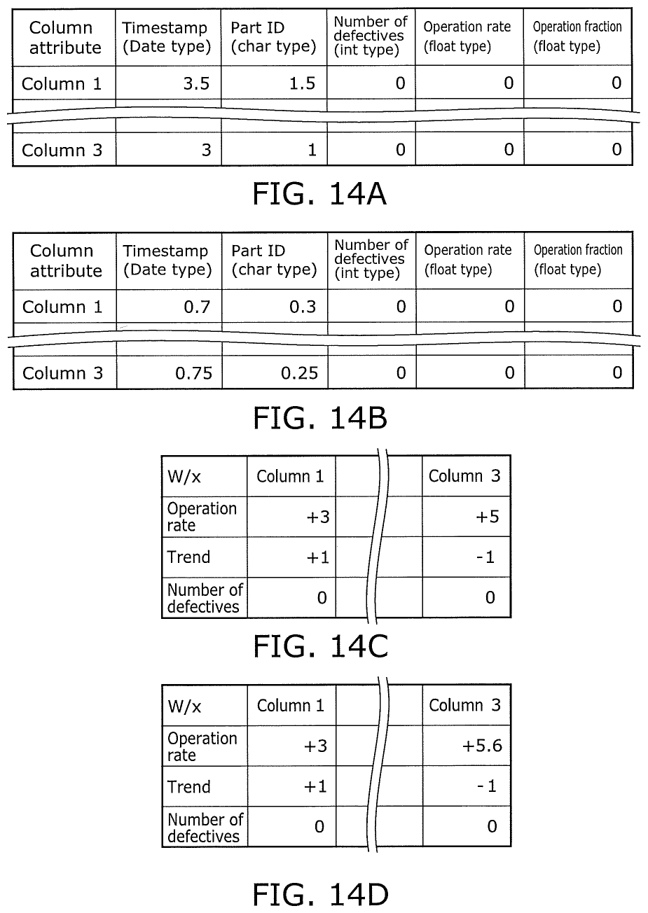

In updating the X-axis table, the update part 16 may further add a point to another column that can have the same column attribute as the column used for the X-axis. This is described with reference to FIGS. 14A to 14D.

FIGS. 14A and 14B are tables illustrating part of the column attribute table. FIGS. 14C and 14D are tables illustrating part of the X-axis table.

FIG. 14A shows part of the column attribute table shown in FIG. 12B. In the example of FIG. 10, column 1 is used for the X-axis. According to the column attribute table shown in FIG. 14A, the attribute of column 1 is “timestamp” or “equipment ID”. The attribute of column 3 is also “timestamp” or “equipment ID”. That is, the column attribute of both of column 1 and column 3 can be “timestamp” or “equipment ID”. In this case, in the X-axis table, a point is added not only to column 1 used for the X-axis but also to column 3. The point added to column 3 increases with the increase of the probability that column 1 and column 3 can have the same column attribute.

A method for calculating the probability is described with reference to a specific example. The proportion of the point of each column attribute to the total point of the column attribute is calculated for each column. In the example of FIG. 14A, this proportion is calculated as shown in FIG. 14B. In the result of FIG. 14B, the probability P(column 1|timestamp) that the attribute of column 1 is “timestamp” is 0.7. The probability P(column 3|timestamp) that the column attribute of column 3 is “timestamp” is 0.75. The probability P(column 1|equipment ID) that the column attribute of column 1 is “equipment ID” is 0.3. The probability P(column 3|equipment ID) that the column attribute of column 3 is “equipment ID” is 0.25. The probability P(column 1, column 3) that column 1 and column 3 have the same column attribute is expressed by the following equation 1.

$$P ( column 1 , column 3 ) = ( P ( column 1 \vert timestamp ) \times P ( column 3 \vert timestamp ) ) + ( P ( column 1 \vert equipment ID ) \times P ( column 3 \vert equipment ID ) ) = 0.7 \times 0.75 + 0.3 \times 0.25 = 0.6 \qquad ( Equation 1 )$$

When the update part 16 adds P1 to the point of column 1 for a keyword in updating the X-axis table, the update part 16 adds point P1′ expressed by the following equation 2 to the point of column 3 for that keyword.

P1′=P1×P(C1,C3) (Equation 2)

For instance, as in the example of FIGS. 13A and 13B, the point of column 1 for “operation rate” is incremented by 1 in updating the X-axis table. At this time, P1′=0.6 is calculated by the aforementioned equation. The update part 16 adds 0.6 to the point of column 3 for “operation rate” as shown in FIGS. 14C and 14D. Likewise, for other combinations of columns, the update part 16 calculates the probability that those columns have the same attribute and adds a point.

This processing can suppress that the point is unevenly added only to a particular combination of a keyword and a column. This can suppress biasing of the evaluation of charts due to e.g. user's preference and tendency.

Consequently, the update of the X-axis table by the update part 16 is completed. The update part 16 performs processing similar to the aforementioned processing for the X-axis table also on the Y-axis table.

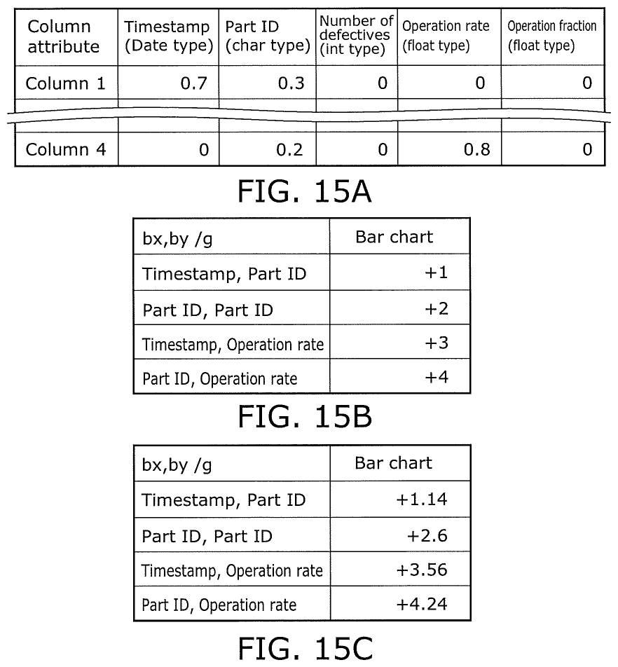

Finally, the update part 16 updates the chart kind table. The update of the chart kind table is described with reference to FIGS. 15A to 15C. FIG. 15A is a table illustrating part of the column attribute table. FIGS. 15B and 15C are tables illustrating part of the chart kind table.

FIG. 15A shows part of the column attribute table shown in FIG. 12B. In this example, the attribute of column 1 can be “timestamp” or “equipment ID”. The attribute of column 4 can be “equipment ID” or “operation rate”. As shown in FIG. 15A, the chart kind table stores the probability that each combination of the attribute of the column used for the X-axis (bx) and the attribute of the column used for the Y-axis (by) can take each kind of chart (g). A higher point in the table indicates a higher probability that the particular kind of chart is used for the combination of column attributes.

The update part 16 updates the chart kind table based on the information of the main table and the information of the column attribute table. Specifically, the point P2′ added to the chart kind table by the update part 16 is expressed by the following equation 3.

P2′=P2×P(bᵢ|x)×P(bⱼ|y) (Equation 3)

P2 is the evaluation (score) of the chart registered by the user in the screen shown in FIG. 11. bᵢ represents the attribute that can be taken by the column used for the X-axis (x). P(bᵢ|x) represents the probability that the column used for the X-axis (x) has the column attribute bᵢ. bⱼ represents the attribute that can be taken by the column used for the Y-axis (y). P(bⱼ|y) represents the probability that the column used for the Y-axis (y) has the column attribute bⱼ. For instance, by the aforementioned equation 3, the probability shown in FIG. 15C is calculated from the points of the column attribute table shown in FIG. 15A.

The aforementioned equation is used to calculate a point for each combination of column attributes. For instance, the additional point for the combination of the X-axis column attribute “timestamp” and the Y-axis column attribute “equipment ID” is 1×0.7×0.2=0.14. As the result of calculation, the update part 16 adds the point to the chart kind table as shown in FIG. 15C. The update part 16 stores the updated chart kind table in the storage device 50.

Consequently, the column attribute table, the X-axis table, the Y-axis table, and the chart kind table are updated. Thus, learning in the display system 1 is completed.

When the user causes the display system 1 to display a chart, the generation part 13 refers to each table stored in the storage device 50. The generation part 13 calculates advisability based on the information of each table and the extracted keyword. The advisability is calculated for a combination of the column used for the X-axis, the column used for the Y-axis, the kind of chart, and the keyword.

### (Calculation of Advisability)

The advisability is calculated by e.g. the following equation 4.

f(x,y,g|W)=P(x|W)×P(y|W)×P(x,Y)×P(g|x,y) (Equation 4)

f(x,y,g|W) represents advisability for a combination of the column used for the X-axis (x), the column used for the Y-axis (y), the kind of chart (g), and the keyword (W).

P(x|W) represents the probability that each column is used for the X-axis when a keyword (W) is extracted. P(x|W) is expressed by the following equation 5.

P(x|W)=Tx(x,W)/ΣᵢTx(i,W) (Equation 5)

Tx(x,W) represents the point of the X-axis column (x) set for a keyword (W) in the X-axis table (Tx). Σᵢ represents summation of the points of the first to i-th columns set for a keyword (W).

Likewise, P(y|W) represents the probability that each column is used for the Y-axis when a keyword (W) is extracted. P(y|W) is expressed by the following equation 6.

P(x|W)=Tx(x,W)/ΣᵢT_{Y}(i,W) (Equation 6)

Tx(x,W) represents the point of the Y-axis column (y) set for a keyword (W) in the Y-axis table (Ty). Σᵢ represents summation of the points of the first to i-th columns set for a keyword (W).

P(x,y) represents whether or not the column used for the X-axis (x) and the column used for the Y-axis (y) are included in the same table. When they are included in the same table, P(x,y) is 1. When they are included in different tables, the chart combining these columns cannot be drawn. Thus, P(x,y) is 0.

P(g|x,y) represents whether or not each kind of chart (g) is used for a combination of the column used for the X-axis (x) and the column used for the Y-axis (y). P(g|x,y) is expressed by the following equation 7.

P(g|x,y)=ΣΣ_{i,j}P(g|bᵢ,bⱼ)×P(bᵢ|x)×P(bⱼ|y) (Equation 7)

P(g|bᵢ,bⱼ) represents the point for the combination of the attribute of the column used for the X-axis (bᵢ) and the attribute of the column used for the Y-axis (bⱼ) set for the kind of chart (g) in the chart kind table. P(g|bᵢ,bⱼ) is expressed by the following equation 8.

P(g|bᵢ,bⱼ)=Tg(g,bᵢ,bⱼ)/Σ_{i,j}Tg(gᵢ,bᵢ,bⱼ) (Equation 8)

Tg(g,bᵢ,bⱼ) represents the point for the combination of the attribute of the column used for the X-axis (bᵢ) and the attribute of the column used for the Y-axis (bⱼ) set for a kind of chart (g) in the chart kind table. Σ_{i,j}Tg(gᵢ,bᵢ,bⱼ) represents the total point for all the kinds of chart (g) set for the combination of the column attribute used for the X-axis (bᵢ) and the column attribute used for the Y-axis (bⱼ).

P(bᵢ|x) represents the point for the column used for the X-axis (x) set for a column attribute (bᵢ) in the column attribute table. P(bⱼ|y) represents the point for the column used for the Y-axis (y) set for a column attribute (bⱼ) in the column attribute table.

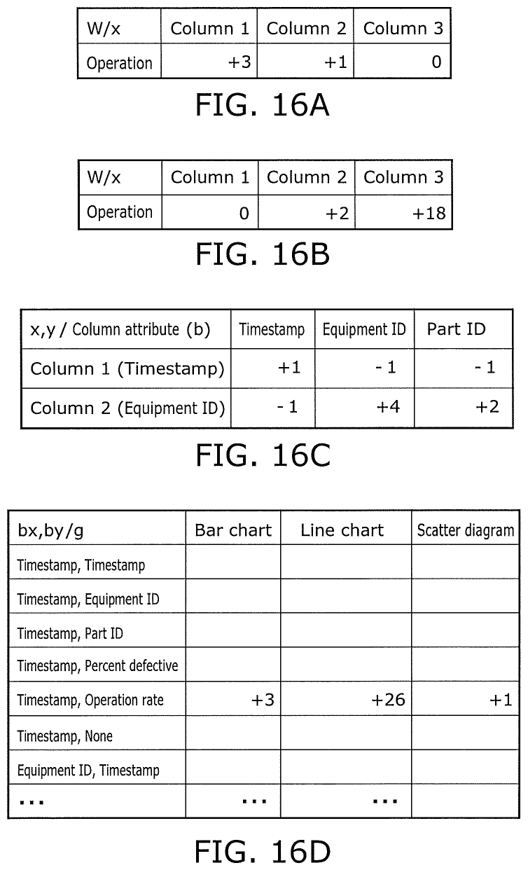

Consequently, the advisability is calculated. An example of the calculation of advisability is described with reference to FIGS. 16A to 16D. FIG. 16A is a table illustrating part of the X-axis table. FIG. 16B is a table illustrating part of the Y-axis table. FIG. 16C is a table illustrating part of the column attribute table. FIG. 16D is a table illustrating part of the chart kind table.

FIGS. 16A to 16D show tables in a state different from that of the example of FIGS. 11 to 15C. As an example, the keyword is “operation”, the attribute of column 1 is “timestamp”, and the attribute of column 2 is “equipment ID”. In this case, calculation of advisability is described in which a bar chart is drawn using column 1 for the X-axis and column 2 for the Y-axis.

Based on the X-axis table shown in FIG. 16A, P(column 1|operation) is expressed by the following equation 9.

$$\begin{matrix}P ( column 1 \vert operation ) = Tx ( column 1 , operation ) \text{/} \\ {Σ}_{i} Tx ( column i , operation ) \\ = 3 / ( 3 + 1 ) = 0.75\end{matrix} \qquad ( Equation 9 )$$

Based on the Y-axis table shown in FIG. 16B, P(column 2l operation) is expressed by the following equation 10.

$$\begin{matrix}P ( column 2 \vert operation ) = Tx ( column 2 , operation ) \text{/} \\ {Σ}_{i} Ty ( column i , operation ) \\ = 2 / ( 2 + 18 ) = 0.1\end{matrix} \qquad ( Equation 10 )$$

The column attribute table shown in FIG. 16C includes column 1 and column 2. Thus, P(column 1,column 2) is 1.

Based on the chart kind table shown in FIG. 16D, P(bar chart|column 1,column 2) is expressed by the following equation 11.

$$P ( bar chart \vert column 1 , column 2 ) = {Σ}_{i , j} P ( bar chart \vert {b}_{i} , {b}_{j} ) \times P ( {b}_{i} \vert column 1 ) \times P ( {b}_{j} \vert column 2 ) = ( Tg ( barchart , timestamp , operation ) / {Σ}_{i} Tg ( {g}_{i} , timestamp , operation ) ) \times P ( timestamp \vert column 1 ) \times P ( equipment ID \vert column 2 ) = ( 3 / ( 3 + 26 + 1 ) ) \times ( 1 / ( 1 ) ) \times 2 / ( 4 + 2 ) = 0.033 \qquad ( Equation 11 )$$

Here, in the column attribute table (Tb), the point below 0 is regarded as 0 in this calculation.

The advisability is calculated as the product of the value calculated by equation 9, the value calculated by equation 10, and the value calculated by equation 11. By the foregoing calculation, the advisability is calculated as 0.0025.

The generation part 13 calculates advisability also for other combinations. The generation part 13 generates one or more charts based on the calculated advisability. For instance, the generation part 13 generates several charts in the descending order of advisability, and the output part 14 displays these charts. When the advisability is displayed on the screen as shown in FIG. 2, another numerical value calculated based on this advisability may be displayed as advisability.

### (Reinforcement Learning)

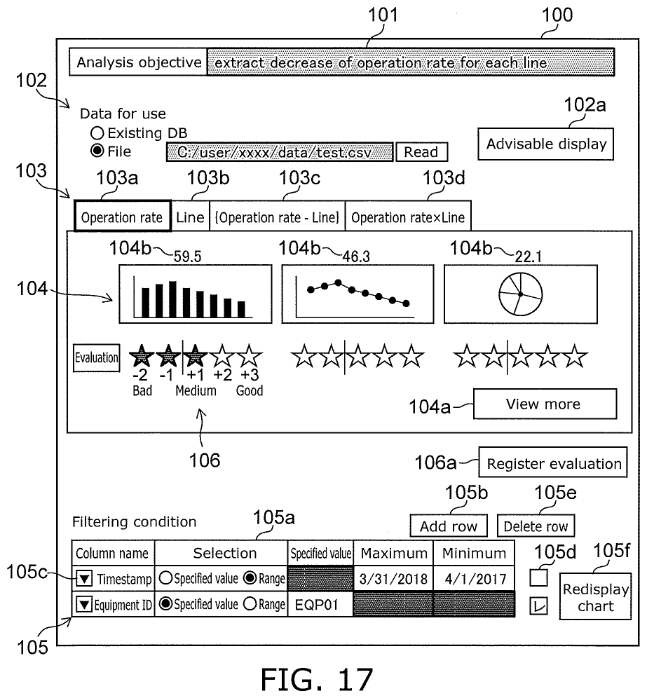

Reinforcement learning may be performed in the display system 1. For instance, as shown in FIG. 17, the output part 14 further displays an item 106 on the screen 100 that displays a chart to the user. The item 106 is used to receive a feedback from the user. In the item 106, the user selects the number of stars displayed below each chart to evaluate the chart. For instance, a larger number of stars indicate that the chart is suitable and useful for the user's analysis objective. After setting the item 106, the user clicks the button 106a to register the evaluation.

Upon clicking the button 106a, the update part 16 updates the main table based on the evaluation. For instance, as shown in FIG. 17, each chart is scored within the range from −2 to +2. The set score is adopted for the selected and scored chart among the charts displayed in the chart display area 104. The score is set to e.g. +1 for the chart that is selected but not scored. The score is set to −1 for the chart that is displayed but not selected. The chart that is not displayed is not reflected in the main table.

After the main table is updated, the update part 16 updates the column attribute table, the X-axis table, the Y-axis table, and the chart kind table similarly to the learning step and stores them in the storage device 50. This enables the display system 1 to display a chart more suitable for the analysis objective when the user uses it subsequently.

### (Ontology)

In extracting the keyword, the display system 1 may use an ontology (conceptual system). An ontology is a dictionary describing various relations between words such as synonym, hypernym/hyponym, antonym, causality, method, and subject/predicate of a sentence. Use of an ontology enables execution of semantic processing between components as opposed to simple comparison between strings representing the components. The ontology may be stored in the storage device 50, or may be stored in another storage device.

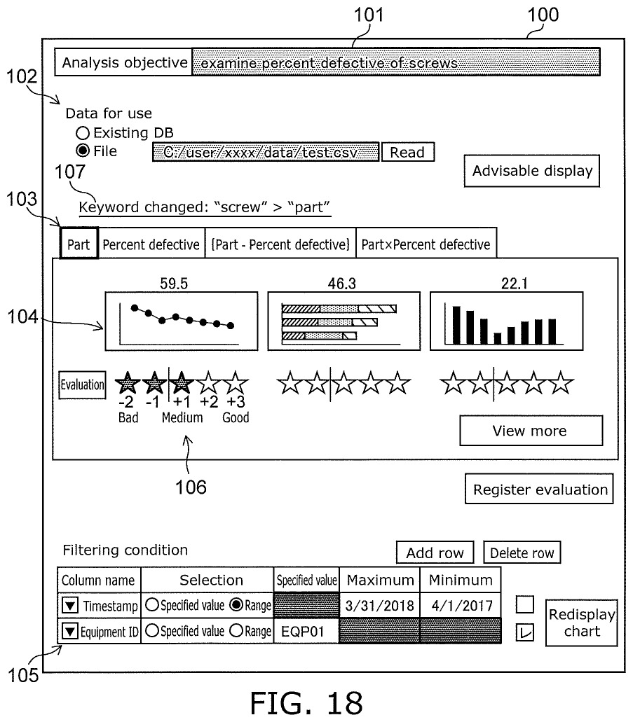

FIG. 18 is a schematic view showing an output example of the display system according to the embodiment.

For instance, as shown in FIG. 18A, the user inputs “examine percent defective of screws” in the input field 101 for inputting a sentence indicating the analysis objective. After the reception part 11 receives the sentence input, the extraction part 12 extracts a keyword from the sentence. The extraction part 12 extracts e.g. “screw” and “percent defective” as keywords. The extraction part 12 refers to the ontology and searches for a word of broader concept for each keyword. For instance, suppose that in the ontology, “screw” has a word of broader concept “part”. In this case, the extraction part 12 outputs “part” and “percent defective” as keywords to the generation part 13. The generation part 13 generates a chart based on these keywords.

Use of an ontology enables generation of a chart adapted to the intent of the sentence even when the sentence of the input field 101 uses a word of narrower concept (subordinate concept).

When the extraction part 12 changes the keyword by referring to the ontology, an annotation 107 is displayed on the screen 100 e.g. as shown in FIG. 18. The annotation displays the word extracted from the sentence inputted by the user and another word (keyword) substituting for that word. The user may be confused when a word not included in the sentence inputted by the user is extracted as a keyword and displayed in the keyword display area 103. By displaying the annotation 107, the user can easily know that a word in the sentence is replaced in generating a chart.

A chart suitable for the user's analysis objective can be easily obtained by using the display system and the display method according to the embodiment described above. Likewise, a program for operating a computer as a display system can be used to cause the computer to generate a chart suitable for the user's analysis objective.

For instance, the display system according to the above embodiment includes the following configurations.

### (Configuration 1)

A display system comprising:

a processing device operable for:
upon receiving a first sentence inputted by a user, extracting a first keyword from the first sentence;
referring to a learned table and generating a first chart related to the first keyword from prescribed data; and
displaying the first chart on a first screen,

in learning of the table, the processing device updating the table based on a second sentence inputted by the user, a second chart displayed based on the second sentence, and an evaluation of the second chart inputted by the user.

### (Configuration 2)

The display system according to configuration 1, wherein

the processing device can receive an evaluation of the first chart by the user in the first screen, and

upon receiving the evaluation of the first chart, the processing device updates the table based on the first sentence, the first chart, and the evaluation of the first chart.

### (Configuration 3)

The display system according to configuration 1 or 2, wherein the processing device extracts a second keyword from the second sentence and updates the table.

### (Configuration 4)

The display system according to configuration 3, wherein

the table includes a main table, and

the processing device incorporates the second keyword, a first column of the data used for an X-axis of the second chart, a second column of the data used for a Y-axis of the second chart, a kind of the second chart, and an evaluation of the second chart into the main table.

### (Configuration 5)

The display system according to configuration 3 or 4, wherein

the table includes a column attribute table related to a plurality of column attributes, and

the column attribute table indicates a probability that one of columns of the data is one of the plurality of column attributes.

### (Configuration 6)

The display system according to any one of configurations 3 to 5, wherein

the table includes an X-axis table, and

the X-axis table indicates a probability that each column of the data is used for an X-axis when the second keyword is used.

### (Configuration 7)

The display system according to any one of configurations 3 to 6, wherein

the table includes a Y-axis table, and

the Y-axis table indicates a probability that each column of the data is used for a Y-axis when the second keyword is used.

### (Configuration 8)

The display system according to any one of configurations 3 to 7, wherein

the table includes a chart kind table related to a plurality of chart kinds, and

the chart kind table indicates a probability that a combination of a column attribute of a column used for an X-axis and a column attribute of a column used for a Y-axis is one of the plurality of chart kinds.

### (Configuration 9)

The display system according to any one of configurations 1 to 8, wherein the processing device is operable for:

calculating each advisability of a plurality of charts based on the first keyword and the table; and

based on the calculated advisability, providing part of the plurality of charts as the first chart.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A display system comprising:
a processing device operable for:
upon receiving a sentence inputted by a user, extracting a keyword from the sentence; and
generating a chart related to the keyword from prescribed data and displaying the chart on a first screen.

2. The system according to claim 1, wherein the processing device displays the extracted keyword on the first screen.

3. The system according to claim 2, wherein when a plurality of the keywords are extracted, the processing device can display a chart based on only one of the keywords on the first screen.

4. The system according to claim 2, wherein when a plurality of the keywords are extracted, the processing device can display a chart based on a combination of the keywords on the first screen.

5. The system according to claim 1, wherein the processing device displays an item for specifying a range of the data used to generate the chart on the first screen.

6. The system according to claim 1, wherein the processing device displays a numerical value indicating relevance between the chart and the sentence on the first screen.

7. The system according to claim 1, wherein the processing device is operable for:
when extracting a word as a possible keyword from the sentence, determining whether there exists another word indicating a broader concept of the word; and
when the other word exists, treating the other word as the keyword.

8. The system according to claim 7, wherein the processing device displays the extracted word and the keyword on the first screen.

9. The system according to claim 1, wherein the processing device can receive an evaluation of the chart by the user in the first screen.

10. A display system comprising:
a processing device operable for:
upon receiving a first sentence inputted by a user, extracting a first keyword from the first sentence;
referring to a learned table and generating a first chart related to the first keyword from prescribed data; and
displaying the first chart on a first screen,
in learning of the table, the processing device updating the table based on a second sentence inputted by the user, a second chart displayed based on the second sentence, and an evaluation of the second chart inputted by the user.

11. The system according to claim 10, wherein
the processing device can receive an evaluation of the first chart by the user in the first screen, and
upon receiving the evaluation of the first chart, the processing device updates the table based on the first sentence, the first chart, and the evaluation of the first chart.

12. A program configured to cause a processing device to perform:
upon input of a sentence by a user, extracting a keyword from the sentence;
generating a chart related to the keyword from prescribed data; and
displaying the chart on a first screen.

13. A storage medium on which the program according to claim 12 is stored.
